(19) United States
(12) Patent Application Publication
(10) Pub. No.: US 2023/0234725 A1
(43) Pub. Date: Jul. 27, 2023

(54) BUMPER, PROTECTIVE WALL STRUCTURE, AND SPACECRAFT

(71) Applicant: MITSUBISHI HEAVY INDUSTRIES, LTD., Tokyo (JP)

(72) Inventors: Takaomi Chubachi, Tokyo (JP); Naoto Azusawa, Tokyo (JP)

(73) Assignee: MITSUBISHI HEAVY INDUSTRIES, LTD., Tokyo (JP)

(21) Appl. No.: 18/159,974

(22) Filed: Jan. 26, 2023

(30) Foreign Application Priority Data
Jan. 27, 2022 (JP) 2022-010927

(51) Int. Cl. B64G 1/56; B64G 1/54

(52) U.S. Cl. CPC B64G 1/56; B64G 1/54

(57) ABSTRACT

A bumper is provided on an outer side of a structural body of a spacecraft with a predetermined gap between the bumper and the structural body. The bumper includes: a first layer that is provided on the outer side and that is formed from an impact resistant material; a second layer that is provided on an inner side being on a side of the structural body with respect to the first layer, the second layer having holes; and a third layer that is provided on the inner side with respect to the second layer, the third layer including a resin.

### CROSS-REFERENCE TO RELATED APPLICATIONS

The present application claims priority to and incorporates by reference the entire contents of Japanese Patent Application No. 2022-010927 filed in Japan on Jan. 27, 2022.

### FIELD

The present disclosure relates to a bumper, a protective wall structure, and a spacecraft.

### BACKGROUND

Conventionally, as a bumper provided to a spacecraft, a light-weighted space debris shield that provides a protection against space debris has been known (for example, see Patent Literature 1). This shield has a layered structure that includes at least two layers, in which at least one of such layers is a liquid layer filled with liquid.

### CITATION LIST

### Patent Literature

Patent Literature 1: Japanese Patent Application Laid-open No. 2011-121476

### SUMMARY

### Technical Problem

To improve the protection performance of a bumper having a multi-layer structure, with respect to its weight, it might be possible to increase the layer thickness, or to use a heavy material having a higher impact resistance. However, if a layer thickness is increased or a heavy material with higher impact resistance is used, the weight of the bumper is also increased.

To address this issue, an object of the present disclosure is to provide a bumper, a protective wall structure, and a spacecraft capable of improving protection performance while suppressing an increase in weight.

### Solution to Problem

A bumper according to the present disclosure is provided on an outer side of a structural body of a spacecraft with a predetermined gap between the bumper and the structural body. The bumper includes: a first layer that is provided on the outer side and that is formed from an impact resistant material; a second layer that is provided on an inner side being on a side of the structural body with respect to the first layer, the second layer having holes; and a third layer that is provided on the inner side with respect to the second layer, the third layer including a resin.

A protective wall structure according to the present disclosure includes: the above-described bumper; and a structural body provided on an inner side with respect to the bumper with a predetermined gap between the bumper and the structural body.

A spacecraft according to the present disclosure includes the above-described protective wall structure.

### Advantageous Effects of Invention

According to the present disclosure, it is possible to improve the protection performance while suppressing an increase in weight.

### BRIEF DESCRIPTION OF DRAWINGS

FIG. 1 is a side view schematically illustrating proximity of a bumper in a spacecraft according to an embodiment.

### DESCRIPTION OF EMBODIMENTS

An embodiment according to the present disclosure will now be explained in detail with reference to the drawing. It should be noted that the embodiment is not intended to limit the scope of the present invention in any way. Elements disclosed below in the embodiment include those that can be replaced or easily replaceable by those skilled in the art, or those that are substantially the same. Furthermore, the elements described below may be combined as appropriate, and, when there are a plurality of embodiments, such embodiment may also be combined.

### First Embodiment

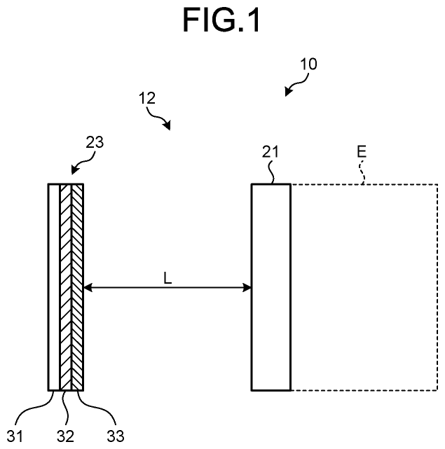

A bumper according to the present disclosure is a bumper provided to a spacecraft, and is configured to provide a protection against a flying object such as a meteorite or space debris. FIG. 1 is a side view schematically illustrating proximity of a bumper in a spacecraft according to an embodiment. To begin with, a spacecraft will be briefly explained with reference to FIG. 1.

Spacecraft

This spacecraft 10 is configured to operate in the space. The spacecraft 10 is a structural body including a pressurized space E internal of which is pressurized. An example of the spacecraft 10 includes a manned lunar rover configured to move on the lunar surface. The spacecraft 10 may also be a rocket, a space station, and an aerospace vehicle, such as a resupply spacecraft that supplies goods to a space station, for example.

The spacecraft 10 has a protective wall structure 12 including a pressurized wall (structural body) 21 forming the pressurized space E, and a bumper 23 protecting the pressurized wall 21. The protective wall structure 12 is a cylinder having a cylindrical shape, for example, and is a structural body serving as an outer shell of the spacecraft 10. The protective wall structure 12 is a structure having a capability for providing protection against a high-speed flying body that flies through the space.

The pressurized wall 21 serves as a partition providing partitioning between the outer space, which is on an outer side, and the pressurized space E that is on an inner side (internal space). The pressurized wall 21 is formed from a composite material including reinforced fibers impregnated with resin. As an example of the composite material, carbon fiber reinforced plastic (CFRP) is used. For the pressurized wall 21, a metal such as aluminum alloy may also be used, without limitation thereto.

Bumper

The bumper 23 will now be explained with reference to FIG. 1. The bumper 23 is provided on the outer side of the pressurized wall 21, and has a predetermined gap L with respect to the pressurized wall 21. The bumper 23 is a member that alleviates the impact of a collision with a flying body, by causing the flying body to scatter. The bumper 23 has a multi-layered structure, and is a structure including at least three layers. An example of the flying body is space debris.

As illustrated in FIG. 1, the bumper 23 includes a first layer 31, a second layer 32, and a third layer 33, in the order listed herein, from the outer side. In the first embodiment, the bumper 23 has a three-layer structure, but another layer may be added between the first layer 31 and the second layer 32, or between the second layer 32 and the third layer 33. At this time, the first layer 31 is provided on the outermost side, and the third layer 33 is provided on the innermost side (on the side of the pressurized wall 21).

The first layer 31 is formed from an impact resistant material. As the impact resistant material for the first layer 31, an impact resistant material having a shock impedance equal to or greater than 2.5×10⁷ [kg/(m²·s)] (the shock impedance herein is a product of a density ρ₀×a bulk sound speed c₀ under an ordinary temperature and an ordinary pressure) is used. Specifically, as the impact resistant material for the first layer 31, stainless steel or ceramics are used.

The second layer 32 is provided between the first layer 31 and the third layer 33, and is a material provided with holes. The second layer 32 is lighter than the first layer 31. The second layer 32 is a meshed material provided with a mesh as the holes, a perforated plate provided with pass-through holes as the holes, or a porous material provided with gaps as the holes, for example. An example of the perforated plate includes a punched metal. Examples of the porous material include a foamed metal or foamed resin. In other words, the density per unit volume of the second layer 32 is equal to or less than that of the impact resistant material of the first layer 31.

The third layer 33 includes resin. The third layer 33 is formed from a low-melting point material having a melting point of 260° C. or lower. Specifically, a resin material is used for the third layer 33, and PET, polymethylpentene, or ABS resin, for example, is used as the resin. The third layer 33 is thicker than the first layer 31 and the second layer 32. The density per unit volume of the third layer 33 is equal to or less than that of the impact resistant material of the first layer 31, in the same manner as the second layer 32. At this time, the density per unit volume of the third layer 33 may be equal to or less than that of the second layer 32.

In the first embodiment, the first layer 31 and the second layer 32 are formed from the same material. In other words, the meshed material of the second layer 32 is formed from the impact resistant material of the first layer 31.

In the protective wall structure 12 according to the first embodiment, once a flying body flying through the space becomes incident on the spacecraft 10, the flying body collides with the bumper 23 of the protective wall structure 12. When the flying body collides with the first layer 31 of the bumper 23, the impact pressure on the first layer 31 becomes increased. Therefore, the first layer 31 promotes crashing, melting, and sublimation of the flying body. The shock waves having propagated through the first layer 31 then become transmitted to the second layer 32 having a lower quasi-density than the first layer 31. At this time, due to the density difference between the first layer 31 and the holed portion of the second layer 32, some of the shock waves become reflected, and reflection waves are generated. The generated reflection waves propagate to the flying body, generate an internal tensile stress inside the flying body, and promote crushing of the flying body. At the same time, because the first layer 31 and the second layer 32 are formed from the same material, the first layer 31 and the non-holed portion of the second layer 32 promote propagation of the shock waves to the third layer 33. Because the propagation of the shock waves to the third layer 33 is promoted, the propagated shock waves facilitate increase of the temperature of the resin in the third layer 33. With melting of the resin facilitated, the third layer 33 reduces the kinetic energy of the flying body.

In the first embodiment, the bumper 23 is explained to provide a protection of the pressurized wall 21, but may be configured to protect any structural body without limitation. Examples of the structural body include an antenna, a cooling pipe, and a solar panel, and the bumper 23 may be configured to protect any of these structural bodies. Furthermore, the bumper 23 may be provided with a radioactive protection function. When a radioactive protection function is provided, a resin material capable of blocking radioactive rays is used in the third layer 33.

### Second Embodiment

A second embodiment will now be explained. In the second embodiment, in order to avoid redundant descriptions, portions that are different from those in the first embodiment will be explained, and the portions that are the same as those in the first embodiment will be explained by giving the same reference numerals. The second embodiment will be explained using FIG. 1.

In a bumper 23 according to the second embodiment, the first layer 31 and the second layer 32 are formed from different materials. In other words, the meshed material of the second layer 32 is formed from a material different from the impact resistant material of the first layer 31.

In the protective wall structure 12 according to the second embodiment, once a flying body flying through the space becomes incident on the spacecraft 10, the flying body collides with the bumper 23 of the protective wall structure 12. When the flying body collides with the first layer 31 of the bumper 23, the impact pressure on the first layer 31 becomes increased. Therefore, the first layer 31 promotes crashing, melting, and sublimation of the flying body. The shock waves having propagated through the first layer 31 then become transmitted to the second layer 32 having a lower quasi-density than the first layer 31. At this time, due to the density difference between the first layer 31 and the holed portion of the second layer 32, some of the shock waves become reflected, and reflection waves are generated. Furthermore, because the first layer 31 and the second layer 32 are formed from different materials, some other of the shock waves become reflected, and reflection waves are generated, also in the first layer 31 and the non-holed part of the second layer 32. Therefore, the generated reflection waves propagate to the flying body, generate an internal tensile stress inside the flying body, and promote crushing of the flying body. Because a resin material is used in the third layer 33, melting of resin reduces the kinetic energy of the flying body.

### Third Embodiment

A third embodiment will now be explained. In the third embodiment, in order to avoid redundant descriptions, portions that are different from those in the first and the second embodiments will be explained, and the portions that are the same as those in the first and the second embodiments will be explained by giving the same reference numerals. The third embodiment, too, will be explained using FIG. 1.

In a bumper 23 according to the third embodiment, the third layer 33 is formed from a composite material including resin and reinforcement fibers. As an example of the composite material, carbon fiber reinforced plastic (CFRP) is used. For the third layer 33 of the bumper 23, the same composite material as the pressurized wall 21 may be used. As the reinforcement fibers, any fibers may be used, and ceramic fibers or alumina fibers, as well as carbon fibers may be used.

In the protective wall structure 12 according to the third embodiment, shock waves propagate through the first layer 31 and the second layer 32 to the third layer 33. The resin in the third layer 33 then melts to reduce the kinetic energy of the flying body, while the reinforcement fibers in the third layer 33 suppress destructions by spalling resultant of the shock waves.

### Fourth Embodiment

A fourth embodiment will now be explained. In the fourth embodiment, in order to avoid redundant descriptions, portions that are different from those in the first to the third embodiments will be explained, and the portions that are the same as those in the first to the third embodiments will be explained by giving the same reference numerals. The fourth embodiment, too, will be explained using FIG. 1.

In a bumper 23 according to the fourth embodiment, the holes of the second layer 32 are filled with the resin of the third layer 33. The holes of the second layer 32 are filled by impregnating the second layer 32 with uncured resin, for example.

In the protective wall structure 12 according to the fourth embodiment, once a flying body flying through the space becomes incident on the spacecraft 10, the flying body collides with the bumper 23 of the protective wall structure 12. When the flying body collides with the first layer 31 of the bumper 23, the impact pressure on the first layer 31 becomes increased. Therefore, the first layer 31 promotes crashing, melting, and sublimation of the flying body. The shock waves having propagated through the first layer 31 then become transmitted to the second layer 32 having a lower quasi-density than the first layer 31. At this time, due to the density difference between the first layer 31 and the holed portion of the second layer 32, some of the shock waves become reflected, and reflection waves are generated. Furthermore, because the resin filled in the holes of the second layer 32 is the same material as the resin in the third layer 33, propagation of the shock waves to the third layer 33 is promoted. Because the propagation of the shock waves to the third layer 33 is promoted, the propagated shock waves facilitate increase of the temperature of the resin in the third layer 33. With melting of the resin facilitated, the third layer 33 reduces the kinetic energy of the flying body.

In the manner described above, the bumper 23, the protective wall structure 12, and the spacecraft 10 described in the embodiments are understood as follows, for example.

The bumper 23 according to a first aspect is a bumper 23 provided on the outer side of a structural body (pressurized wall 21) of the spacecraft 10, with a predetermined gap L therebetween, the bumper 23 including: the first layer 31 that is provided on the outer side, and that is formed from an impact resistant material; the second layer 32 that is provided on the inner side being on the side of the structural body with respect to the first layer 31, and that is provided with holes; and the third layer 33 that is provided on the inner side with respect to the second layer 32, and that includes resin.

With this structure, the first layer 31 promotes crashing, melting, and sublimation of the flying body, by increasing the impact pressure on the flying body; the second layer 32 promotes crashing of the flying body by generating reflection waves at an early stage; and the third layer 33 reduces the kinetic energy of the flying body by the melting of the resin. Therefore, it is possible to improve the protection performance of the bumper 23 while suppressing an increase in weight.

As a second aspect, the second layer 32 is a meshed material, a perforated plate, or a porous material.

With this structure, a light-weighted material suitable for the second layer 32 can be used.

As a third aspect, the third layer 33 is thicker than the first layer 31 and the second layer 32.

With this structure, by increasing the thickness of the light-weighted third layer 33 including resin, it becomes possible to further improve the protection performance of the bumper 23, while suppressing an increase in weight.

As a fourth aspect, the impact resistant material having a shock impedance of 2.5×10⁷ [kg/(m²·s)] or higher is used for the first layer 31.

With this structure, it is possible to achieve an impact resistant material suitable for the first layer 31 by which the flying body can be crushed.

As a fifth aspect, a low-melting point material having a melting point of 260° C. or lower is used for the third layer 33.

With this structure, preferably, it is possible to cause the third layer 33 to melt by the tensile stress of the shock waves.

As a sixth aspect, the third layer 33 has a radioactive protection function for blocking radioactive rays.

With this structure, it is possible to suppress entry of the radioactive rays into a main structure.

As a seventh aspect, the first layer 31 and the second layer 32 are formed from the same material.

With this structure, it is possible to promote propagation of the shock waves through the first layer 31 and the non-holed portion of the second layer 32 to the third layer 33. Therefore, it is possible to raise the temperature of the resin in the third layer 33, and the kinetic energy of the flying body is further reduced by facilitating melting of the resin in the third layer 33.

As an eighth aspect, the first layer 31 and the second layer 32 are formed from different materials.

With this structure, because the reflection waves can be generated at an early stage even in the first layer 31 and the non-holed portion of the second layer 32, it is possible to promote crushing of the flying body further.

As a ninth aspect, a composite material containing the resin described above and a reinforcement fiber is used as the third layer 33.

With this structure, the reinforcement fibers in the third layer 33 can suppress destructions by spalling resultant of the shock waves.

As a tenth aspect, the holes of the second layer 32 are filled with the resin of the third layer 33.

With this structure, it is possible to promote propagation of the shock waves through the resin filled in the holes in the second layer 32 to the third layer 33 via. Therefore, it is possible to raise the temperature of the resin in the third layer 33, and the kinetic energy of the flying body is further reduced by facilitating melting of the resin in the third layer 33.

As an eleventh aspect, the first layer 31 is provided on the outermost side, and the third layer 33 is provided on the innermost side.

With this structure, the layers with respect to the main structure can be arranged by which the protection performance is preferably exerted.

The protective wall structure 12 according to a twelfth aspect includes the bumper 23, and a structural body provided on the inner side with respect to the bumper 23 with a predetermined gap L therebetween.

With this structure, it is possible to provide the protective wall structure 12 with an improved protection performance, while suppressing an increase in weight.

As a thirteenth aspect, the structural body is a pressurized wall internal of which is pressurized.

With this structure, it is possible to provide the protective wall structure 12 having a pressurized wall with improved protection performance.

The spacecraft 10 according to a fourteenth aspect includes the protective wall structure 12.

With this structure, it is possible to provide the protective wall structure 12 with a high protection performance while suppressing an increase in the weight of the spacecraft 10.

### REFERENCE SIGNS LIST

10 Spacecraft
12 Protective wall structure
21 Pressurized wall
23 Bumper
31 First layer
32 Second layer
33 Third layer

1. A bumper that is provided on an outer side of a structural body of a spacecraft with a predetermined gap between the bumper and the structural body, the bumper comprising:
a first layer that is provided on the outer side and that is formed from an impact resistant material;
a second layer that is provided on an inner side being on a side of the structural body with respect to the first layer, the second layer having holes; and
a third layer that is provided on the inner side with respect to the second layer, the third layer including a resin.

2. The bumper according to claim 1, wherein the second layer is formed from a meshed material, a perforated plate, or a porous material.

3. The bumper according to claim 1, wherein the third layer is thicker than the first layer and the second layer.

4. The bumper according to claim 1, wherein the impact resistant material included in the first layer has a shock impedance of 2.5×10⁷ [kg/(m²·s)] or higher.

5. The bumper according to claim 1, wherein the third layer includes a low-melting point material having a melting point of 260° C. or lower.

6. The bumper according to claim 1, wherein the third layer has a radioactive protection function for blocking radioactive rays.

7. The bumper according to claim 1, wherein the first layer and the second layer are formed from a same material.

8. The bumper according to claim 1, wherein the first layer and the second layer are formed from different materials.

9. The bumper according to claim 1, wherein the third layer includes a composite material containing the resin and a reinforcement fiber.

10. The bumper according to claim 1, wherein the holes of the second layer are filled with the resin of the third layer.

11. The bumper according to claim 1, wherein the first layer is provided on an outermost side, and the third layer is provided on an innermost side.

12. A protective wall structure comprising:
the bumper according to claim 1; and
a structural body provided on an inner side with respect to the bumper with a predetermined gap between the bumper and the structural body.

13. The protective wall structure according to claim 12, wherein the structural body is a pressurized wall internal of which is pressurized.

14. A spacecraft comprising the protective wall structure according to claim 12.
